(19) United States
(12) Patent Application Publication
(10) Pub. No.: US 2026/0352521 A1
(43) Pub. Date: Nov. 5, 2026

(54) END-TO-END LEARNING FRAMEWORK FOR MIMO COMMUNICATIONS

(71) Applicants: Samsung Electronics Co., Ltd., Suwon-si (KR); The University of Texas at Austin, Austin, TX (US)

(72) Inventors: Karl CHAHINE, San Jose, CA (US); Hyeji KIM, Austin, TX (US); Jung Hyun BAE, San Diego, CA (US)

(21) Appl. No.: 19/654,448

(22) Filed: Apr. 21, 2026

Related U.S. Application Data
(60) Provisional application No. 63/798,535, filed on May 1, 2025.

(51) Int. Cl. H04L 25/03; G06N 3/045; G06N 3/08; H04B 7/0413

(52) U.S. Cl. CPC H04L 25/03165; G06N 3/045; G06N 3/08; H04B 7/0413; H04L 2025/03426

(57) ABSTRACT

A communication system includes a transmitter processing chain and a receiver processing chain for multiple-input multiple-output (MIMO) communications, in which respective signal-processing functions are implemented as learnable neural networks. The transmitter processing chain may include an encoder, a modulator, a power allocator, and a precoder, and the receiver processing chain may include a combiner, an equalizer or power deallocator, a demodulator, and a decoder. In some embodiments, channel-specific information derived from a channel matrix is provided to selected neural networks, including right singular vectors to a precoder neural network, left singular vectors to a combiner neural network, and singular values to an equalizer neural network. In some embodiments, individual neural network blocks are pretrained using analytical solutions or simplified channel models and are subsequently fine-tuned jointly in an end-to-end manner to improve reliability, adaptability, and performance under varying MIMO channel conditions.

### CROSS-REFERENCE TO RELATED APPLICATIONS

This application claims the benefit of U.S. Provisional Patent Application Ser. No. 63/798,535, filed May 1, 2025, which is incorporated by reference herein for all purposes.

### TECHNICAL FIELD

The disclosure relates to wireless communication systems and, more particularly, to multiple-input multiple-output (MIMO) transmission and reception techniques employing neural network-based architectures for transmitters and receivers in which signal-processing functions are implemented as learnable modules and jointly optimized for end-to-end communication performance.

### SUMMARY

The present background section is intended to provide context only, and the disclosure of any concept in this section does not constitute an admission that said concept is prior art.

Some wireless communication systems increasingly employ multiple-input multiple-output (MIMO) techniques to improve spectral efficiency, reliability, and throughput by exploiting spatial diversity and multipath propagation. Some MIMO transceivers implement a sequence of signal-processing functions (e.g., channel encoding, modulation, precoding, equalization, demodulation, and decoding) using analytically derived algorithms optimized under simplifying assumptions about channel conditions and noise characteristics. Machine learning approaches have been proposed in which portions of the transmitter and receiver, or even the entire end-to-end communication chain, are modeled as neural networks trained to maximize performance metrics such as bit-error rate or throughput. However, existing neural network-based communication systems often treat the transceiver as a monolithic structure or rely on limited learning within individual components, which can reduce interpretability, increase training complexity, and limit adaptability to varying channel environments, particularly in MIMO scenarios requiring coordinated processing across multiple antennas.

Some MIMO communication systems employ monolithic end-to-end architectures or limited learning within isolated components, resulting in high training complexity, poor interpretability, reduced flexibility, and difficulty incorporating domain knowledge such as channel structure or practical power constraints. These limitations hinder the ability of existing systems to efficiently adapt to diverse MIMO channel conditions while maintaining scalable implementations. Accordingly, there is a need for a communication framework that can jointly optimize transmitter and receiver processing using learnable models while preserving a modular structure, leveraging channel-specific information, supporting efficient training procedures, and achieving improved performance and robustness in practical MIMO systems.

The disclosed techniques provide a neural network-based framework for MIMO communications in which the transmitter and receiver are decomposed into a sequence of functional processing units (e.g., encoder, modulator, power allocator, precoder, combiner, equalizer, demodulator, and decoder) each implemented as a learnable neural network tailored to its respective signal-processing role. By preserving the modular structure of a conventional communication chain while replacing analytical algorithms with trainable models, the framework enables coordinated optimization across the entire system while maintaining interpretability and implementation flexibility. The architecture further incorporates channel-specific information, including components derived from the channel matrix, to guide processing within selected modules, and employs a staged training methodology in which individual blocks may be pre-trained using analytical solutions or simplified channel models and subsequently fine-tuned jointly for end-to-end performance. This approach allows the system to adapt to diverse and time-varying MIMO conditions, satisfy practical constraints such as transmit power limits, and achieve improved reliability and efficiency compared to conventional model-based or monolithic learning-based designs.

In various embodiments, the systems and methods described herein include systems, methods, and apparatuses for an end-to-end learning framework for MIMO communications.

In some aspects, the techniques described herein relate to a communication system including: a transmitter processing chain including an encoder neural network, a modulator neural network, and a precoder neural network; a receiver processing chain including a combiner neural network, an equalizer neural network, a demodulator neural network, and a decoder neural network; and a processor configured to obtain a channel matrix for a multiple-input multiple-output channel and to derive, from a singular value decomposition of the channel matrix, one or more right singular vectors, one or more left singular vectors, and one or more singular values, wherein: the precoder neural network is configured to receive the one or more right singular vectors and to generate a precoding output for application to modulation symbols generated by the modulator neural network; the combiner neural network is configured to receive the one or more left singular vectors and to generate a combining output for processing a received signal; and the equalizer neural network is configured to receive the one or more singular values and to generate an equalization output for compensating channel-dependent distortion prior to demodulation and decoding.

In some aspects, the techniques described herein relate to a communication system, wherein: the encoder neural network and the modulator neural network are implemented as a combined encoder-modulator neural network, and the demodulator neural network and the decoder neural network are implemented as a combined demodulator-decoder neural network.

In some aspects, the techniques described herein relate to a communication system, further including a power allocator neural network configured to: receive signal-to-noise ratio information and equalization-related information; and generate a power allocation output for application to symbols produced by the modulator neural network, the power allocator neural network being disposed before the precoder neural network.

In some aspects, the techniques described herein relate to a communication system, further including a power deallocator neural network configured to: receive the signal-to-noise ratio information and the equalization-related information; and generate a receiver-side compensation output that compensates for transmit-side power allocation and channel-induced gain variation, the power deallocator neural network being disposed in the receiver processing chain.

In some aspects, the techniques described herein relate to a communication system, wherein: the modulator neural network is configured to receive groups of M encoded symbols and generate a respective complex-valued modulation symbol for each group, and the demodulator neural network is configured to receive a complex-valued received symbol and to generate M real-valued outputs corresponding to the complex-valued received symbol.

In some aspects, the techniques described herein relate to a communication system, wherein: the modulator neural network is applied to each of the groups of M encoded symbols using shared learned parameters, and the demodulator neural network is applied to each received complex-valued symbol of a plurality of received complex-valued symbols.

In some aspects, the techniques described herein relate to a communication system, wherein the one or more singular values are provided to the equalizer neural network as diagonal elements of a diagonal matrix or as a vector formed from the diagonal elements.

In some aspects, the techniques described herein relate to a communication system, wherein, for each of a plurality of time instances, the one or more right singular vectors, the one or more left singular vectors, and the one or more singular values correspond to a same channel matrix associated with the respective time instance.

In some aspects, the techniques described herein relate to a communication system, wherein a transmit signal obtained by applying the precoding output to modulation symbols is normalized to satisfy a transmit power constraint before transmission over the multiple-input multiple-output channel.

In some aspects, the techniques described herein relate to a communication system, wherein the communication system is configured for point-to-point wireless communication between a user equipment and a base station.

In some aspects, the techniques described herein relate to a method of training a neural network-based communication system for multiple-input multiple-output communications, the method including: pretraining an encoder neural network and a decoder neural network; pretraining at least two neural networks selected from a group consisting of a precoder neural network, a combiner neural network, and an equalizer neural network using channel-decomposition information derived from one or more channel matrices; connecting the encoder neural network, the decoder neural network, and the at least two neural networks in an end-to-end communication chain; and jointly fine tuning, based on the pretraining, the end-to-end communication chain.

In some aspects, the techniques described herein relate to a method, wherein pretraining the encoder neural network and the decoder neural network includes training the encoder neural network and the decoder neural network on an additive white Gaussian noise channel before the encoder neural network and the decoder neural network are used in the multiple-input multiple-output communications.

In some aspects, the techniques described herein relate to a method, wherein pretraining the precoder neural network, the combiner neural network, and the equalizer neural network includes training the precoder neural network using one or more right singular vectors as labels, training the combiner neural network using one or more left singular vectors as labels, and training the equalizer neural network using one or more singular values as labels.

In some aspects, the techniques described herein relate to a method, further including pretraining a power allocator neural network using a water-filling power allocation for a multiple-input multiple-output channel sample and signal-to-noise ratio information.

In some aspects, the techniques described herein relate to a method, wherein jointly fine tuning the end-to-end communication chain includes minimizing a binary cross-entropy loss between input bits and decoded output bits.

In some aspects, the techniques described herein relate to a method, wherein the channel matrices correspond to a fast-fading channel in which the channel matrices vary across time instances or to a slow fading channel in which a same channel matrix is held across a transmission block.

In some aspects, the techniques described herein relate to a method, further including: training a modulator neural network that maps groups of M encoded symbols to complex-valued modulation symbols; and training a demodulator neural network that maps each received complex-valued symbol to M real-valued outputs.

In some aspects, the techniques described herein relate to a non-transitory computer-readable medium storing instructions that, when executed by one or more processors, cause the one or more processors to: obtain information bits for transmission over a multiple-input multiple-output channel; obtain a channel matrix and derive, from a singular value decomposition of the channel matrix, one or more right singular vectors, one or more left singular vectors, and one or more singular values; encode the information bits using an encoder neural network; modulate encoded outputs using a modulator neural network to generate modulation symbols; generate, using at least one neural network selected from a group consisting of a precoder neural network, a combiner neural network, and an equalizer neural network, at least one output selected from a group consisting of: a precoding output generated based on the one or more right singular vectors; a combining output generated based on the one or more left singular vectors; and an equalization output generated based on the one or more singular values; and recover an estimate of the information bits by demodulating and decoding a received signal based on the at least one output.

In some aspects, the techniques described herein relate to a non-transitory computer-readable medium, wherein the instructions further cause the one or more processors to generate, using a power allocator neural network that receives signal-to-noise ratio information and equalization-related information, a power allocation output before generation of the precoding output.

In some aspects, the techniques described herein relate to a non-transitory computer-readable medium, wherein the instructions further cause the one or more processors to generate, using a power deallocator neural network that receives the signal-to-noise ratio information and the equalization-related information, a receiver-side compensation output after generation of the combining output.

A computer-readable medium is disclosed. The computer-readable medium can store instructions that, when executed by a computer, cause the computer to perform substantially the same or similar operations as described herein are further disclosed. Similarly, non-transitory computer-readable media, devices, and systems for performing substantially the same or similar operations as described herein are further disclosed.

The systems and methods described herein include multiple advantages and benefits. For example, the disclosed techniques provide a structured neural network-based MIMO communication framework that combines the performance benefits of end-to-end learning with the practicality and interpretability of a modular signal-processing architecture. By implementing each functional stage of the transmitter and receiver as a dedicated learnable neural network, the system enables coordinated optimization across encoding, modulation, precoding, equalization, and decoding while preserving clear functional boundaries that facilitate design, debugging, and deployment. Incorporation of channel-specific information (e.g., parameters derived from the channel matrix, etc.) allows the system to exploit spatial characteristics of MIMO channels more effectively than conventional model-based methods or generic learning approaches. The staged training strategy, including pre-training of individual modules followed by joint fine-tuning, improves training efficiency, stability, and convergence while reducing data requirements. Additionally, the framework can adapt to varying channel conditions, practical power constraints, and hardware limitations, leading to improved reliability, spectral efficiency, and robustness in real-world wireless environments. Thus, the disclosed techniques offer a scalable and flexible pathway to achieving increased communication performance without sacrificing real-world applicability.

The disclosed neural network-based communication framework demonstrates concrete, physically measurable performance improvements that directly translate into reduced latency, improved power efficiency, and enhanced reliability. In particular, end-to-end joint optimization of the encoder, modulator, precoder, combiner, and decoder eliminates inefficiencies associated with independently designed modules, thereby reducing redundant processing and shortening the effective signal-processing pipeline. This reduction in processing overhead inherently lowers latency while also decreasing computational energy consumption. Empirical results show that the learned system achieves up to approximately a 2 dB performance gain over other LTE Turbo-based systems, which corresponds to requiring lower transmit power to achieve the same bit error rate (BER), or equivalently achieving lower BER at the same power level, thereby directly evidencing improved power efficiency and link reliability. Further, analysis of learned representations demonstrates adaptive constellation shaping and stream-wise power allocation (e.g., selective suppression of weaker spatial streams), which reduces unnecessary signal transmission and receiver processing burden, contributing to both lower power consumption and simplified decoding complexity. Additionally, the structured pretraining and SVD-guided initialization significantly improve convergence behavior relative to naïve end-to-end training, reducing training time and computational cost while enabling stable deployment in real-time systems. Collectively, these results provide concrete evidence that the neural network modules yield tangible physical-layer benefits, including reduced transmission power requirements, improved spectral efficiency, faster convergence (lower training latency), and more efficient real-time signal processing compared to conventional architectures.

### BRIEF DESCRIPTION OF THE DRAWINGS

In the following section, the aspects of the subject matter disclosed herein will be described with reference to exemplary embodiments illustrated in the figures, in which:

These and other features and advantages of the present disclosure will be appreciated and understood with reference to the specification, claims, and appended drawings, wherein:

FIG. 1 illustrates an example system in accordance with one or more implementations as described herein.

FIG. 2 illustrates an example wireless communications system in accordance with one or more implementations as described herein.

FIGS. 3-5 illustrate example MIMO systems in accordance with one or more implementations as described herein.

FIG. 6 is a block diagram of an electronic device in a network environment, according to an embodiment.

FIG. 7 shows a system including a UE and a gNB in communication with each other.

FIG. 8 depicts a flow diagram illustrating an example method associated with the disclosed systems, in accordance with example implementations described herein.

While the present systems and methods are susceptible to various modifications and alternative forms, specific embodiments thereof are shown by way of example in the drawings and will herein be described. The drawings may not be to scale. It should be understood, however, that the drawings and detailed description thereto are not intended to limit the present systems and methods to the particular form disclosed, but to the contrary, the intention is to cover all modifications, equivalents, and alternatives falling within the spirit and scope of the present systems and methods as defined by the appended claims.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms, and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms, and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

Some communication systems employ a modular architecture in which functional components such as channel coding, modulation, precoding, and combining are designed and optimized independently. While such approaches have achieved strong performance under idealized assumptions, they inherently rely on each component operating as if adjacent components behave optimally. In practical environments, however, these assumptions do not hold, particularly under finite block lengths, non-Gaussian channel conditions, or imperfect channel state information. As a result, mismatches between independently optimized components accumulate across the signal chain, leading to degraded end-to-end performance and suboptimal bit error rate characteristics.

Some systems may use end-to-end neural network-based communication systems in which the transmitter and receiver are modeled as a single monolithic architecture. While conceptually appealing, such designs lack structural guidance and are difficult to train effectively, particularly in complex multiple-input multiple-output (MIMO) environments. In practice, these systems often exhibit poor convergence behavior and fail to achieve competitive performance without significant architectural constraints or initialization strategies.

Additionally, some systems that decompose transmitter and receiver functionality into smaller neural network-based modules do not provide a MIMO-specific structure that defines how individual modules should be configured or what inputs they should receive. Although such systems may include modular neural processing blocks, they generally do not incorporate channel-aware representations, such as singular value decomposition (SVD) components, or structured relationships between modules tailored to MIMO channel characteristics. As a result, these approaches do not fully leverage available domain knowledge and are limited in their ability to efficiently learn optimal transmission and reception strategies.

Further, some systems may lack an effective training methodology for complex communication systems. Naïve end-to-end training from random initialization has been shown to converge poorly in high-dimensional MIMO settings due to the complexity of jointly optimizing multiple interacting components. Without structured pretraining or staged optimization strategies, such systems are prone to suboptimal solutions and limited generalization across varying channel conditions.

Accordingly, there remains a need for improved communication system architectures and training methodologies that enable coordinated, end-to-end optimization across all functional components, while incorporating domain-specific structure to achieve robust and efficient performance in practical MIMO environments.

The present disclosure provides a neural network-based communication architecture for MIMO systems in which transmitter and receiver functionalities are jointly optimized through a structured, end-to-end learning framework. In contrast to conventional designs, the disclosed system decomposes both the transmitter and receiver into a plurality of functional units, including an encoder, modulator, power allocator, precoder, combiner, equalizer, demodulator, and decoder, where each functional unit is implemented as a respective learnable neural network. These functional units may be arranged in a processing chain spanning from input information bits at the transmitter to reconstructed information bits at the receiver, thereby enabling coordinated optimization across the entire communication pipeline.

Some aspects of the disclosed architecture include a structured design of neural network inputs for MIMO channel processing. In particular, the precoder neural network is configured to receive one or more right singular vectors of a channel matrix as input, the combiner neural network is configured to receive one or more left singular vectors of the channel matrix as input, and the equalizer neural network is configured to receive one or more singular values of the channel matrix as input. By leveraging singular value decomposition (SVD) components of the channel, the disclosed system incorporates domain-specific channel structure directly into the learning process, thereby reducing learning complexity and improving convergence and performance relative to approaches that operate on raw channel representations.

In a singular value decomposition of a channel matrix expressed as H=UΣV, the terms “right singular vectors” and “left singular vectors” may denote the respective positions of these vector sets within the decomposition rather than any spatial direction. The right singular vectors, represented by the columns of matrix (V), appear on the right side of the decomposition and correspond to orthogonal directions in the input or transmit space, thereby characterizing how signals are introduced into the channel. The left singular vectors, represented by the columns of matrix (U), appear on the left side of the decomposition and correspond to orthogonal directions in the output or receive space, thereby characterizing how signals are observed after propagation through the channel. Accordingly, the designation “right” may signify association with the transmit-side representation of the channel, while “left” may signify association with the receive-side representation, such that the decomposition may be interpreted as mapping input-aligned signals through channel-dependent scaling defined by Σ into output-aligned signals.

In some embodiments, the system further includes a neural network-based power allocator positioned prior to the precoder and a corresponding power deallocator or equalizer at the receiver. The power allocator neural network is configured to receive signal-to-noise ratio (SNR) information and channel-derived features, and to generate power allocation parameters for transmission. This enables adaptive, learned power distribution across spatial streams in a manner that generalizes classical power allocation techniques while remaining fully integrated within an end-to-end learning framework.

The disclosed system may additionally incorporate neural modulation and demodulation blocks. In such embodiments, groups of encoded symbols are provided as inputs to a neural modulator that generates complex-valued transmission symbols, while a neural demodulator may be configured to process received complex symbols to produce corresponding real-valued outputs for decoding. This structure enables flexible and learnable symbol mapping and demapping operations that are jointly optimized with the remaining system components.

The disclosed techniques include a structured training methodology for the described MIMO systems. The training process may include a pretraining phase followed by an end-to-end fine-tuning phase. During pretraining, selected components may be initialized using domain-informed supervision, including training encoder and decoder networks on additive white Gaussian noise (AWGN) channels, training precoder, combiner, and equalizer networks using target singular vectors and singular values derived from channel decomposition, and training power allocation networks based on established power allocation strategies. Following pretraining, functional units may be jointly fine-tuned in an end-to-end manner to optimize overall system performance, thereby enabling coordinated adaptation across all components.

Accordingly, the disclosed invention provides a structured, modular, and fully trainable communication system architecture that integrates domain-specific channel representations with neural network-based functional units and a staged training strategy, thereby enabling improved end-to-end performance, scalability, and adaptability in MIMO communication environments.

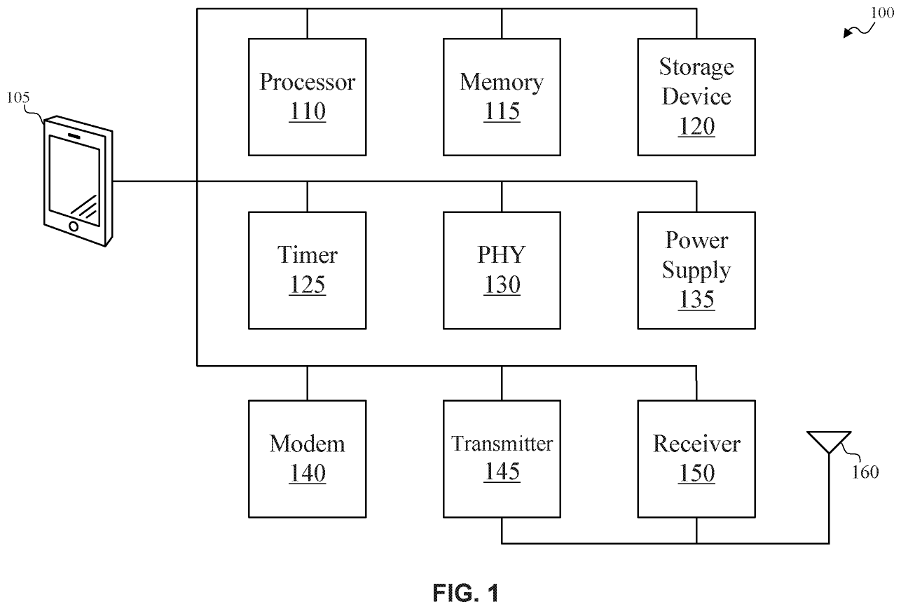

FIG. 1 illustrates an example of a system 100, of a wireless communications network, that supports an end-to-end learning framework for MIMO communications with example implementations described herein.

As shown, system 100 may include device 105. Device 105 may include a mobile device, a cellphone, a smartphone, a tablet, a laptop, a wearable computing device, an Internet-of-things device, a user equipment (UE), a vehicle (e.g., autonomous vehicle), any device configured to transmit and/or receive a wireless signal, or any wireless/wired network-connected device. As shown, device 105 may include a processor 110, a memory 115, a storage device 120, a timer 125, a physical layer (PHY) 130, a power supply 135, a modem 140, at least one transceiver (e.g., transmitter 145, receiver 150), and at least one antenna (e.g., antenna 160). Device 105 may communicate with one or more devices via at least antenna 160 and at least one network (e.g., short-range wireless communication network, long-range wireless communication network).

In some cases, device 105 may include an input device, a sound output device, a display device, an audio module, a sensor module, an interface, a haptic module, a camera module, a communication module, a subscriber identification module (SIM) card, or an antenna module. In one embodiment, at least one component (e.g., display device, camera module) may be omitted from device 105, or one or more other components may be added to device 105. Some of the components may be implemented as a single integrated circuit (IC). For example, a sensor module (e.g., a fingerprint sensor, an iris sensor, or an illuminance sensor) may be embedded in a display of device 105.

In some cases, processor 110 may execute software (e.g., a program) to control at least one other component (e.g., a hardware, a software component, etc.) of device 105 coupled with processor 110. Processor 110 may perform various data processing or computations. As at least part of the data processing or computations, processor 110 may load a command or data received from another component (e.g., receiver 150, etc.) in memory 115, process the command or the data stored in memory 115, and store resulting data in storage device 120. In some cases, processor 110 may include a main processor (e.g., a central processing unit (CPU) or an application processor (AP)), and an auxiliary processor (e.g., a graphics processing unit (GPU), an image signal processor (ISP), a sensor hub processor, and/or a communication processor (CP)) that is operable independently from, or in conjunction with, the main processor. Additionally, or alternatively, the auxiliary processor may be adapted to consume less power than the main processor, or execute a particular function. The auxiliary processor may be implemented as being separate from, or a part of, the main processor.

In some examples, memory 115 may store various data used by at least one component (e.g., processor 110, etc.) of device 105. The various data may include, for example, software (e.g., a program, application) and input data or output data for a command related thereto. In some cases, memory 115 may include volatile memory (e.g., random-access memory (RAM) dynamic RAM (DRAM), static RAM (SRAM)) and/or non-volatile memory (e.g., NAND flash memory). In some cases, memory 115 and/or storage device 120 may include internal memory and/or external memory. One or more programs may be stored in the memory 115 as software, and may include, for example, an operating system (OS), middleware, and/or an application.

In some cases, timer 125 may be configured to time one or more operations, indicate or measure a time period, indicate a lapse of time, indicate an expiration, indicate a timeout, etc. In some cases, timer 125 may be configured to indicate a lapse of time, indicate an expiration, and/or indicate a timeout in relation to one or more components of device 105. For example, timer 125 may be configured to indicate a lapse of time and/or provide a clock cycle in relation to an operation of one or more components of device 105.

In some examples, PHY 130 may include an electronic circuit configured to implement physical layer functions of the open systems interconnection (OSI) model (e.g., in conjunction with a network interface controller of device 105). PHY 130 may connect a link layer device (e.g., medium access control (MAC) to a physical medium of device 105 (e.g., radio waves, electromagnetic radiation, radiofrequency (RF) energy).

In some examples, power supply 135 (e.g., a battery, a power adapter, power management module, etc.) may supply power to at least one component of device 105. In some examples, power supply 135 may include, for example, a cell (e.g., primary cell) that is not rechargeable, a cell (e.g., secondary cell) that is rechargeable, a fuel cell, etc.

A communication module of device 105 may support establishing a direct (e.g., wired) communication channel and/or a wireless communication channel between device 105 and at least one external electronic device, and performing communication via the established communication channel. The communication module may include one or more communication processors that are operable independently from processor 110 and may support a direct (e.g., wired) communication and/or a wireless communication. The communication module may include a wireless communication module (e.g., a cellular communication module, a short-range wireless communication module, transmitter 145, receiver 150, antenna 160, etc.) or a wired communication module (e.g., a local area network (LAN) communication module, a power line communication (PLC) module, etc.). A corresponding one of these communication modules may communicate with the external electronic device via at least a first network (e.g., a short-range communication network, such as BLUETOOTH®, wireless-fidelity (Wi-Fi) direct, a standard of the Infrared Data Association (IrDA)) or a second network (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module may identify and/or may authenticate device 105 in a communication network using subscriber information (e.g., international mobile subscriber identity (IMSI)) stored in the subscriber identification module.

In some examples, antenna 160 (e.g., of transmitter 145 and/or receiver 150) may transmit a signal (e.g., RF energy) to and/or receive a signal from or one or more devices external to device 105. Antenna 160 may include one or more antennas. For example, antenna 160 may include at least one antenna appropriate for a communication scheme used in the communication network. A signal or power received by antenna 160 may be received by receiver 150 of device 105, and/or a signal or power transmitted by antenna 160 may be generated by transmitter 145.

Commands or data may be transmitted or received between device 105 and an external electronic device via a server coupled to at least one network. All or some of the operations executed at device 105 may be executed at one or more external electronic devices. For example, if device 105 performs a function or a service automatically, or in response to a request from a user or another device, device 105, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to device 105. The device 105 may provide the outcome, with or without further processing of the outcome, as at least part of a reply to the request. To that end, a cloud computing, distributed computing, or client-server computing technology may be used, for example.

In some implementations, processor 110, memory 115, and storage device 120 may collectively execute and store neural network models implementing a communication chain in accordance with the techniques described herein. Modem 140 and PHY 130 may interface with the physical communication medium, while transmitter 145 and receiver 150 may perform signal transmission and reception via antenna 160.

Within this architecture, processor 110 may execute a neural network-based MIMO communication framework in which signal-processing functions of the transmitter 145 and receiver 150 (e.g., encoding, modulation, precoding, equalization, demodulation, and decoding) may be implemented as modular, learnable components. These components may operate over data stored in memory 115 and coordinated through modem 140/PHY 130 to generate transmit signals and process received signals.

Timer 125 and power supply 135 may support timing control and power management for these operations, enabling real-time communication and training/inference execution. System 100 therefore integrates neural-network-based communication processing directly into a device architecture, allowing end-to-end learned transmission and reception to be executed by processor 110 in conjunction with the communication hardware stack.

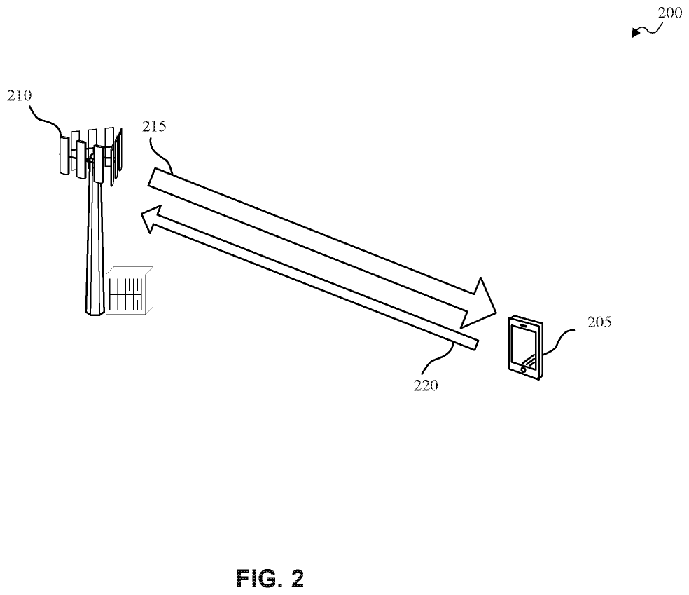

FIG. 2 illustrates an example of a wireless communications system 200, of a wireless communications network, that supports an end-to-end learning framework for MIMO communications in accordance with example implementations described herein.

As illustrated, wireless communications system 200 may include device 205 and base station 210. Device 205 may be an example of device 105 of FIG. 1. Base station 210 may connect device 205 to a core network (e.g., a central, high-speed backbone of a telecommunications network, responsible for routing data and connecting different parts of the network). As shown, wireless communications system 200 may include downlink 215 and uplink 220. Base station 210 may use downlink 215 to convey control and/or data information to device 205. And device 205 may use uplink 220 to convey control and/or data information to base station 210. In some cases, downlink 215 may use different time and/or frequency resources than uplink 220. In some cases, base station 210 may be associated with a geographic coverage area in which communications with one or more UEs (e.g., device 205) is supported.

Based on the techniques described herein, user device 205 and/or base station 210 implement a neural network-based MIMO communication framework in which transmission and reception operations associated with downlink 215 and uplink 220 may be performed using modular, learnable functional units. For example, information transmitted over downlink 215 from base station 210 to the device 205 may be generated using neural network-based transmitter-side processing (e.g., encoding, modulation, precoding, and power allocation), while signals received at the device 205 may be processed using corresponding neural network-based receiver-side processing (e.g., combining, equalization, demodulation, and decoding). Similarly, uplink transmissions from the device 205 to base station 210 may be generated and processed using analogous neural network-based functional units.

System 200 enables end-to-end learned communication between the device 205 and base station 210, where both uplink and downlink signal paths may be optimized jointly or semi-independently using trained neural network modules that exploit MIMO channel characteristics. By integrating these learnable functional units within the communication paths (e.g., downlink 215 and uplink 220), system 200 can adapt transmission and reception strategies based on channel conditions, improve spectral efficiency and reliability, and support dynamic optimization across both directions of communication while maintaining compatibility with a conventional wireless network architecture.

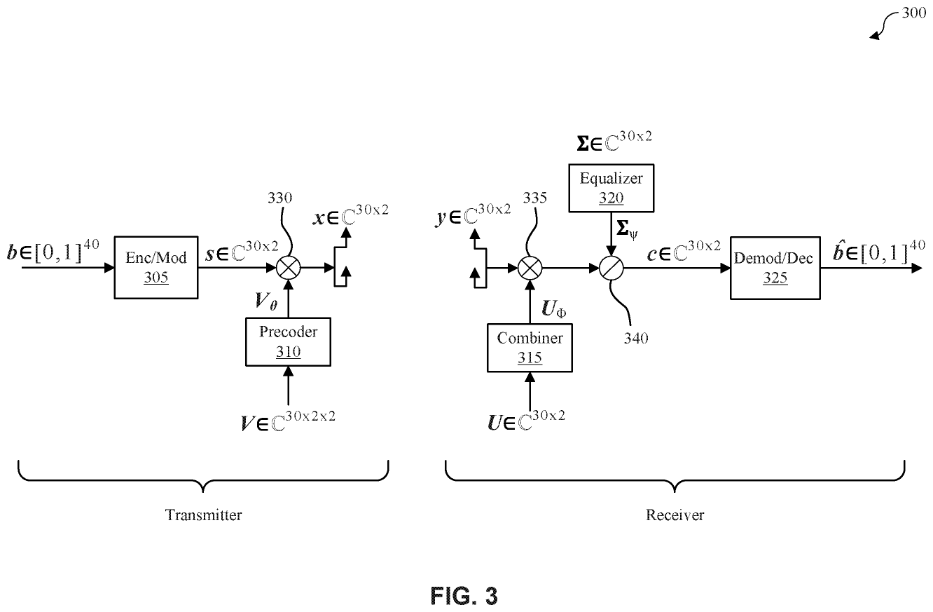

FIG. 3 illustrates a MIMO system 300 in accordance with one or more implementations as described herein. In some configurations, one or more aspects of MIMO system 300 may be implemented by or in conjunction with device 105, components of device 105, or any combination thereof.

In the illustrated example, MIMO system 300 is partitioned into a transmitter-side processing chain and a receiver-side processing chain. As shown, MIMO system 300 includes encoder modulator 305, precoder 310, combiner 315, equalizer 320, and demodulator decoder 325. Encoder modulator 305 and precoder 310 are disposed on a transmit path, while combiner 315, equalizer 320, and demodulator decoder 325 are disposed on a receive path.

FIG. 3 is based on an example configuration with K=40 information bits (e.g., input bit sequence b has a length of 40), n=120 coded symbols, T=30 timesteps, a modulation order of M=2, and N_{Tx}=N_{Rx}=2 antennas. However, additional configurations are contemplated (e.g., M=64 to M=4096; N=4 to N=64, including element array configurations from 128 elements up to 1024 elements, etc.).

The output s may be arranged across multiple channel uses and spatial streams corresponding to an N-transmit-antenna configuration. For example, the spatial streams may correspond to two-transmit-antenna configuration, where a first dimension corresponds to channel uses and a second dimension corresponds to spatial streams.

In the illustrated example, transmit signal x propagates through a communication channel and is received as a signal y∈ [symbol] at the receiver side. The received signal y may reflect effects of a channel matrix and additive noise. In accordance with associated disclosure materials, at a given time instance a received signal may be expressed as yₜ=Hₜxₜ+zₜ, where Hₜ∈ [symbol] is the channel matrix and zₜ∈ [symbol] is the additive white Gaussian noise vector with variance σ². In the illustrated configuration, the received signal y maintains dimensionality corresponding to 30 channel uses and two receive antennas.

In some examples, encoder modulator 305 and/or demodulator decoder 325 may be configured with a deep-learning-based channel coding scheme (e.g., Turbo Autoencoder, TurboAE), replacing handcrafted encoder/decoder components with neural networks, which may be designed to emulate the performance of turbo codes. In some cases, encoder modulator 305 and demodulator decoder 325 may be configured as an end-to-end autoencoder where encoder modulator 305 acts as a transmitter and demodulator decoder 325 acts as a receiver, trained together to minimize bit error rates over noisy channels.

On the transmitter side, encoder modulator 305 receives input data bits b∈[0,1]⁴⁰ and performs channel encoding and modulation to generate symbol stream s∈ [symbol] . In some embodiments, encoder modulator 305 may implement forward error correction and constellation mapping, thereby producing modulation symbols suitable for spatial processing. Output of encoder modulator 305 may be provided to precoder 310.

In some embodiments, precoder 310 may be implemented using a neural network that takes channel right singular vectors as inputs, thereby enabling adaptive beamforming or spatial multiplexing tailored to channel conditions. As shown, precoder 310 receives matrix V∈ [symbol] , where V represents right singular vectors of a channel matrix obtained from singular value decomposition of the channel. Precoder 310 may apply a transmit-side transformation based on channel-aware or learned parameters, such as precoding matrix V∈ [symbol] Precoder 310 outputs precoding V_{θ} based on the input V. In some embodiments, precoder 310 may be implemented as a neural network parameterized by θ and configured to generate V_{θ} responsive to the input V.

As shown, transmit-side mixing from mixer 330 (e.g., multiplier) combines V_{θ} to s∈ [symbol] , producing transmit signal x∈ [symbol] . In some embodiments, transmit signal x may be obtained by applying precoding output V_{θ} to s.

In the illustrated example, signal x is transmitted over a communication channel and received as signal y∈ [symbol] at the receiver side. Using combining matrix U∈ [symbol] , combiner 315 may generate combined signal U_{Φ}. In some cases, U∈ [symbol] may be derived from channel left singular vectors and/or learned representations.

Equalizer 320 may perform post-combining equalization based on channel singular values or equivalent parameters. As shown, equalizer 320 may use matrix Σ∈ [symbol] to generate equalization signal Σ_{ψ}. In some embodiments, equalizer 320 is implemented as a neural network parameterized by ψ and configured to compensate for channel distortion using Σ. The matrix Σ∈ [symbol] may be derived from channel singular values. For example, equalizer 320 may be implemented using a neural network configured to operate on singular value information of channel matrix, thereby compensating for channel distortion and improving symbol estimation accuracy.

In the illustrated signal chain, mixer 335 (e.g., multiplier) combines received signal y∈ [symbol] with the output Up from combiner 315, thereby producing a spatially combined signal. This combined signal and equalization signal Σ_{ψ} are then processed by multiplier 340 to produce equalized signal c∈ [symbol] , prior to demodulation. It is noted that multiplier 340 may be referred to as a multiplier or a divider, as division by x is equivalent to multiplication by 1/x. In some cases, mixer 335 may apply a weight or a combining weight (e.g., Up from combiner 315) to the incoming received signal y∈ [symbol] .

Multiplier 340 may perform a complex phase rotation on each element of the input signal, preserving the magnitude of the signal while adjusting its phase. In some cases, such phase adjustment may be performed on a per-stream or per-symbol basis. After combining using U_{Φ}, residual phase offsets may remain due to channel effects, imperfect synchronization, and/or learned transformations within combiner 315. Multiplier 340 may compensate for these offsets so that constellation points are properly oriented in the complex plane before demodulation.

In some examples, multiplier 340 may be part of a learned normalization or conditioning stage that prepares the combined signal for equalization. Because equalizer 320 receives Σ∈ [symbol] , which corresponds to learned scaling factors associated with singular values, multiplier 340 may ensure that phase distortions are separated from amplitude distortions, allowing equalizer 320 to focus on magnitude (gain) compensation, while phase alignment is handled upstream.

Demodulator decoder 325 may receive equalized signal c∈ [symbol] and perform demodulation and decoding to recover estimated data bits \hat{b}∈[0,1]⁴⁰. In some cases, demodulator decoder 325 may implement inverse operations corresponding to encoder modulator 305, including constellation demapping and error-correcting code decoding. Demodulator decoder 325 may implement demodulation and decoding corresponding to operations performed by encoder modulator 305.

In some embodiments, precoder 310, combiner 315, and equalizer 320 are implemented as respective neural networks that are configured based on distinct components of a singular value decomposition of a channel matrix, including right singular vectors V, left singular vectors U, and singular values Σ. Such configuration enables adaptive signal processing tailored to channel characteristics while maintaining modular functional partitioning across transmit and receive processing paths.

Thus, FIG. 3 depicts an end-to-end learned or hybrid signal processing pipeline in which transmitter-side processing (encoder modulator 305 and precoder 310) and receiver-side processing (combiner 315, equalizer 320, and demodulator decoder 325) cooperate to enable efficient and adaptive communication over a channel characterized by singular value decomposition-based features.

In MIMO system 300, a channel matrix (H) may be decomposed using singular value decomposition (SVD) as H=UΣV^{H}. In this decomposition, V is a matrix whose columns correspond to right singular vectors, U is a matrix whose columns correspond to left singular vectors, and Σ is a diagonal matrix whose diagonal elements correspond to singular values. Each of these components captures a distinct structural characteristic of the channel and may be utilized as an input to a respective neural network component within the system.

Right singular vectors, represented as columns of matrix V, correspond to orthogonal directions in a transmit antenna space. Each right singular vector defines a spatial transmission mode through which signals may be propagated across a channel. In this regard, right singular vectors characterize how transmitted signals may be spatially shaped or precoded prior to transmission. Accordingly, in some embodiments, a precoder neural network (e.g., precoder 310) receives at least a portion of matrix V, or one or more right singular vectors V, as an input and generates a precoding matrix based thereon. By operating on right singular vectors, precoder neural network may learn a mapping that aligns transmitted signals with channel-dependent transmission modes.

Left singular vectors, represented as columns of matrix U, correspond to orthogonal directions in a receive antenna space. Each left singular vector defines a spatial reception mode through which received signals may be projected or combined. In this regard, left singular vectors characterize how received signals may be spatially combined to separate transmitted data streams. Accordingly, in some embodiments, a combiner neural network receives at least a portion of matrix U, or one or more left singular vectors U, as an input and generates a combining matrix based thereon. By operating on left singular vectors, a combiner neural network (e.g., combiner 315) may learn a mapping that facilitates separation and recovery of transmitted signals at a receiver.

Singular values may be represented by diagonal elements of matrix Σ, which may be interpreted as a vector of values corresponding to gains associated with respective spatial transmission modes. Each singular value may quantify a strength of a corresponding channel mode and reflect an effective gain experienced by a transmitted signal along that mode. Because matrix Σ is diagonal, singular values may be treated as a set of scalar values rather than a full matrix. Accordingly, in some embodiments, an equalizer neural network (e.g., equalizer 320) receives the singular values, or a vector formed from diagonal elements of matrix Σ, as an input and generates equalization parameters based thereon. By operating on singular values, equalizer neural network may learn a mapping that compensates for channel-dependent gain variations across multiple spatial streams.

In some embodiments, use of right singular vectors, left singular vectors, and singular values as inputs to respective neural networks enables decomposition of a MIMO channel into a plurality of independent spatial modes, thereby reducing inter-stream interference and facilitating parallel processing of transmitted signals. Such structured inputs may reduce complexity relative to directly processing channel matrix H, while preserving channel characteristics relevant to precoding, combining, and equalization operations.

Thus, the disclosed techniques provide a domain-guided approach that leverages the singular value decomposition (SVD) of the channel. The right singular vectors V, left singular vectors U, and singular values Σ are fed into dedicated neural networks that learn the precoder (V_{θ}), combiner (U_{φ}), and equalizer (Σ_{ψ}). Combined with a deep-learning-based channel coding scheme for coding and modulation (e.g., TurboAE, encoder modulator 305, demodulator decoder 325), the disclosed systems and methods lead to significantly improved performance.

It is noted that MIMO system 300 may be trained using a combination of pre-training (e.g., encoder/decoder training on additive white Gaussian noise channels, supervised training of other modules, etc.) followed by end-to-end fine tuning, enabling coordinated optimization across all functional units.

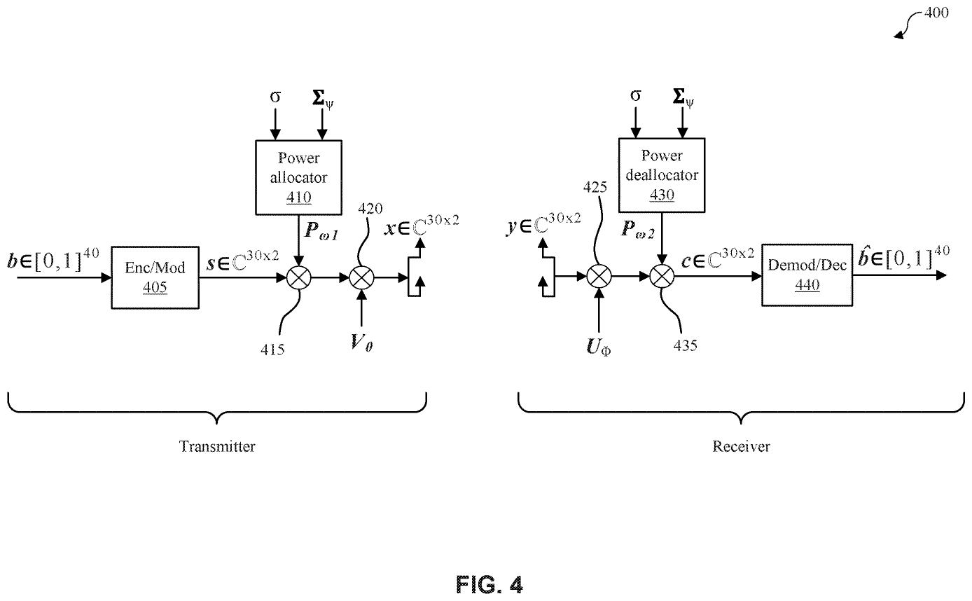

FIG. 4 illustrates an example MIMO system 400 in accordance with one or more implementations as described herein. In some configurations, one or more aspects of MIMO system 400 may be implemented by or in conjunction with device 105, components of device 105, or any combination thereof.

In some implementations, FIG. 4 represents an example MIMO communication chain in which both spatial-domain processing and power-domain processing are incorporated into an end-to-end learnable architecture. One or more aspects of FIG. 4 may be similar to one or more corresponding aspects of FIG. 3, where FIG. 4 further depicts power allocator 410 (e.g., power allocator neural network) disposed on the transmitter side and power deallocator 430 (e.g., power deallocator neural network) disposed on the receiver side. FIG. 4 is based on an example configuration with K=40 information bits (e.g., input bit sequence b has a length of 40), n=120 coded symbols, T=30 timesteps, a modulation order of M=2, and N_{Tx}=N_{Rx}=2 antennas. However, additional configurations are contemplated (e.g., M=64 to M=4096; N=4 to N=64, including element array configurations from 128 elements up to 1024 elements, etc.).

FIG. 4 includes encoder modulator 405, power allocator 410, power deallocator 430, and demodulator decoder 440. Encoder modulator 405 and power allocator 410 are disposed along a transmit processing chain, and power deallocator 430 and demodulator decoder 440 are disposed along a receive processing chain. Although not explicitly illustrated as separate blocks in FIG. 4, precoder processing corresponding to output V_{θ} (e.g., via precoder 310) and combiner processing corresponding to output U_{Φ} (e.g., via combiner 315) may be present in MIMO system 400, consistent with FIG. 3 and associated description. Thus, in some embodiments, outputs V_{θ} and U_{Φ} may be generated by a precoder neural network and a combiner neural network, respectively.

In the illustrated example, encoder modulator 405 receives input data bits b∈[0,1]⁴⁰ and generates a sequence of complex-valued symbols s∈ [symbol] . In some examples, encoder modulator 405 performs channel encoding and modulation to map the input bit sequence into a modulated signal suitable for transmission over a MIMO channel. The output s may be arranged across multiple channel uses and spatial streams corresponding to an N-transmit-antenna configuration. For example, the spatial streams may correspond to two-transmit-antenna configuration, where a first dimension corresponds to channel uses and a second dimension corresponds to spatial streams.

In the depicted implementation, power allocator 410 receives input information associated with signal-to-noise ratio denoted as σ and equalization-related information denoted as Σ_{ψ}. Equalization-related information may refer to channel-derived parameters and/or intermediate processing outputs that characterize channel-induced distortion and used to generate or guide equalization operations within the receiver processing chain. In the context of the disclosed system, such equalization-related information may include one or more singular values of the channel matrix (e.g., elements of Σ obtained from a singular value decomposition of the channel matrix), which represent per-stream channel gains and are directly used by the equalizer neural network to compensate for amplitude distortion across spatial streams. In addition, the equalization-related information may include outputs of an equalizer neural network (e.g., Σ_{ψ}), representing learned scaling or compensation factors derived from the singular values, as well as channel state information such as noise variance or signal-to-noise ratio (SNR), which influence the degree of equalization applied. In embodiments incorporating power allocation, the equalization-related information may further include features reflecting interactions between channel gain and applied transmit power (e.g., inputs to or outputs from a power allocator or deallocator neural network), thereby enabling coordinated compensation of both channel distortion and power-induced effects. Collectively, the equalization-related information thus may include channel gain indicators, learned equalization parameters, and optionally noise or power-related metrics, some or all of which enable the receiver-side neural network modules to correct channel-dependent distortion prior to demodulation and decoding.

As shown, power allocator 410 may generate a power allocation output P_{ω1}, which may control allocation of transmit power across elements of symbol sequence s, including across spatial streams and/or channel uses. As shown, the output P_{ω1} may be applied to s via mixer 415 to produce a power-shaped signal, thereby adjusting relative magnitudes of transmitted symbols in accordance with channel conditions, signal-to-noise ratio, and learned allocation strategy.

Following application of power allocation, the power-shaped signal may be further processed based on mixer 420 applying precoder output V_{θ} to the power-shaped signal. Although FIG. 4 does not explicitly illustrate a precoder block, precoder processing remains present and produces V_{θ}. Precoder output V_{θ} may be applied after power allocation such that already power-shaped symbol streams may be mapped onto channel-aware spatial transmission modes. This ordering reflects a design in which power allocation is performed prior to spatial mapping. As shown, application of V_{θ} via mixer 420 produces transmit signal x∈ [symbol] , which represents a spatially multiplexed signal prepared for transmission over a MIMO channel.

In the illustrated example, transmit signal x propagates through a communication channel and is received as a signal y∈ [symbol] at the receiver side. The received signal y may reflect effects of a channel matrix and additive noise. In accordance with associated disclosure materials, at a given time instance a received signal may be expressed as yₜ=Hₜxₜ+zₜ, where Hₜ∈ [symbol] is the channel matrix and zₜ∈ [symbol] is the additive white Gaussian noise vector with variance σ². In the illustrated configuration, the received signal y maintains dimensionality corresponding to 30 channel uses and 2 receive antennas.

On the receiver side, received signal y may be processed based on mixer 425 applying combiner output U_{Φ} to received signal y. Although FIG. 4 does not explicitly illustrate a combiner block, combiner processing may be present and generate U_{Φ}, which may be applied to y via mixer 425. In some cases, combiner processing projects or transforms received signal y onto receive-side spatial modes associated with the channel structure. This combining operation may mitigate inter-stream interference and produce a combined signal representation aligned with downstream processing.

The combined signal may be provided to mixer 435. Mixer 435 receives the combined signal and further receives input information associated with signal-to-noise ratio σ and equalization-related information Σ_{ψ}. In some cases, power deallocator 430 may receive signal-to-noise ratio and equalizer-related information as input, and, based on these inputs, power deallocator 430 may generate a power deallocation output P_{ω2}, which may adjust the combined signal to undo or rebalance power shaping introduced by power allocator 410 and modified by channel effects. Power deallocator 430 may replace an equalizer neural network of MIMO system 400 in some embodiments. Accordingly, power deallocator 430 may be understood as implementing receiver-side processing that compensates for power allocation applied at the transmitter and for channel-induced gain variations.

As shown, application of P_{ω2} via mixer 435 may produce a processed signal c∈ [symbol] . In some cases, the signal c is therefore a post-combining and post-deallocation representation of the received transmission that has been transformed toward a form suitable for demodulation and decoding. In this sense, power deallocator 430 may perform a function analogous to or replacing equalization, while also incorporating knowledge of transmit-side power allocation.

As shown, demodulator decoder 440 receives c∈ [symbol] and performs demodulation and channel decoding to generate an estimate f the transmitted bit sequence \hat{b}∈[0,1]⁴⁰. Demodulator decoder 440 may convert complex-valued symbols into decoded bit estimates corresponding to the original input bits, thereby completing the end-to-end communication process.

Accordingly, FIG. 4 depicts an end-to-end communication chain in which encoder modulator 405 generates modulated symbols from input bits b, power allocator 410 applies transmit-side power shaping based on signal-to-noise ratio and equalization-related information, precoder processing maps signals onto spatial transmission modes using V_{θ}, the communication channel conveys transmit signal x to received signal y, combiner processing generates a combined representation using U_{Φ}, power deallocator 430 compensates for transmit-side power allocation and channel effects using P_{ω2}, and demodulator decoder 440 reconstructs the transmitted bit sequence \hat{b}. Thus, the inclusion of power allocator 410 and power deallocator 430 may enable coordinated optimization of both power-domain and spatial-domain processing within a modular neural network-based MIMO architecture.

In this embodiment, both power allocator 410 and power deallocator 430 may operate as learnable neural network modules that receive channel-dependent information and cooperate with precoder and combiner processing. The depicted architecture enables MIMO system 400 to jointly optimize transmit power distribution, spatial mapping, and receiver-side compensation, thereby improving performance under varying channel conditions while maintaining a modular structure in which each functional unit performs a distinct role within the overall communication chain.

In some examples, FIG. 4 depicts an embodiment that builds upon and extends the architecture of FIG. 3 by incorporating additional functional units, including power allocator 410 and power deallocator 430. Thus, one or more components or operations of FIG. 3 may be implemented in FIG. 4, and FIG. 4 may be understood as a modified or augmented realization of the FIG. 3 architecture in which power allocation functionality is integrated into the transmitter and receiver processing chain. Accordingly, elements such as encoder modulator 405, precoder-related processing, combiner-related processing, and equalizer-related processing in FIG. 4 correspond to, or may be implemented using, respective components of FIG. 3, with additional processing stages inserted before and/or after such components.

It is noted that MIMO system 400 may be trained using a combination of pre-training (e.g., encoder/decoder training on additive white Gaussian noise channels, supervised training of other modules, etc.) followed by end-to-end fine tuning, enabling coordinated optimization across all functional units.

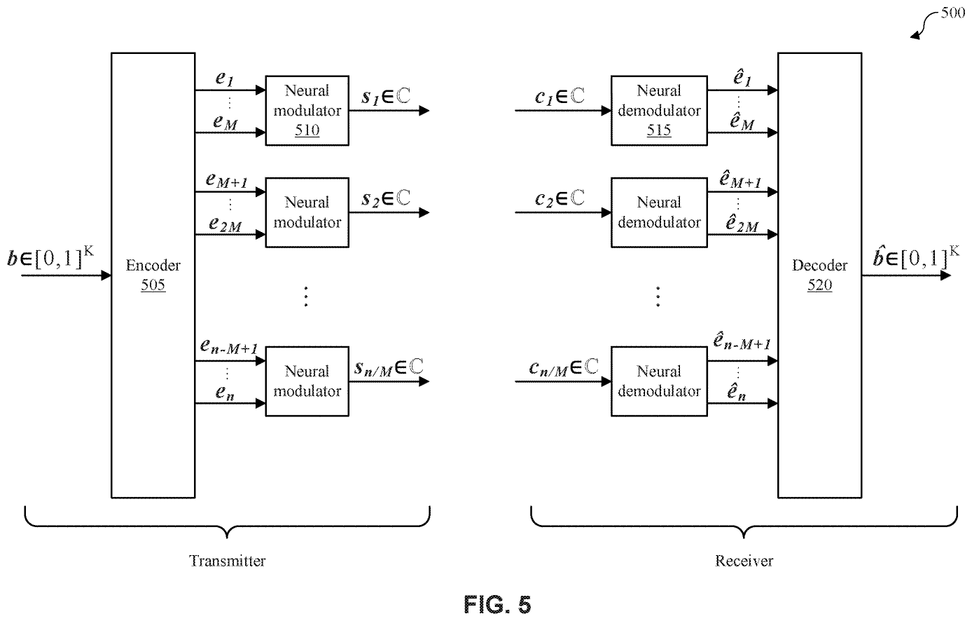

FIG. 5 illustrates an example MIMO system 500 in accordance with one or more implementations as described herein. In some configurations, one or more aspects of MIMO system 500 may be implemented by or in conjunction with device 105, components of device 105, or any combination thereof.

On the transmitter side of MIMO system 500, FIG. 5 depicts encoder 505 and one or more neural modulators that includes at least neural modulator 510. On the receiver side of MIMO system 500, FIG. 5 depicts one or more neural modulators that includes at least neural demodulator 515 and decoder 520.

FIG. 5 illustrates an end-to-end neural modulation and demodulation architecture integrated within a MIMO communication system, in which modulation and demodulation operations are implemented using one or more learnable neural network blocks distributed across transmitter and receiver communication chains. The architecture extends the modular neural communication framework by introducing neural modulation at the transmitter output and neural demodulation at the receiver input, thereby enabling joint learning of symbol mapping and recovery in conjunction with encoding and decoding operations.

On the transmitter side, FIG. 5 depicts encoder 505 receiving an input bit sequence b∈[0,1]^{K} and generating encoded symbols that are provided to one or more neural modulators, including at least neural modulator 510. Encoder 505 may implement a neural channel encoder (e.g., based on a Turbo Autoencoder architecture), transforming the input bit sequence into a sequence of encoded real-valued or intermediate symbols. These encoded symbols may be partitioned into groups of M elements, where M corresponds to a modulation order (e.g., M=2 to M=4096). Each group of M symbols may be provided as input to a respective neural modulator block, such as neural modulator 510, which generates a corresponding complex-valued modulation symbol s_{I}∈ [symbol] .

In some implementations, neural modulator 510 (e.g., and additional neural modulators) may operate to map consecutive or otherwise grouped subsets of encoded symbols (e.g., e₁ . . . e_{M}, e_{M+1} . . . e_{2M}, e_{n-M+1} . . . eₙ) into complex-valued outputs (e.g., s₁, s₂, . . . s_{n/M}), thereby producing a sequence of transmit symbols. Each neural modulator may share parameters or operate as identical network instances to ensure consistent mapping across symbol groups, although alternative embodiments may employ distinct parameterizations. This grouping-and-mapping process may enable MIMO system 500 to learn modulation constellations that are optimized jointly with the encoder 505 and downstream MIMO processing, rather than relying on fixed constellations such as quadrature amplitude modulation (QAM).

The resulting sequence of complex-valued symbols may be transmitted over a communication channel, such as a MIMO fading channel, and received at the receiver side as a sequence of received symbols (e.g., c₁, c₂, . . . , c_{n/M}). As shown, on the receiver side, FIG. 5 depicts one or more neural demodulators, including at least neural demodulator 515, which process the received complex-valued symbols. A given neural demodulator may take a corresponding received symbol (e.g., c_{I}∈ [symbol] , c₂∈ [symbol] , c_{n/M}∈ [symbol] , etc.) and generate a set of estimated real-valued outputs (e.g., ê₁ . . . ê_{M}, ê_{M+1} . . . ê_{2M}, ê_{n-M+1} . . . êₙ), representing reconstructed encoded symbols. This operation may invert (e.g., effectively invert) the transmitter-side grouping, converting each complex-valued symbol back into multiple real-valued components consistent with the original encoder output structure.

As shown, the set of estimated real-valued outputs may be provided to decoder 520, which may perform decoding operations to estimate the original bit sequence, producing an output bit estimate \hat{b}ₑ[0,1]^{K}. In some cases, the outputs of the neural demodulators may be reassembled into a reconstructed sequence, preserving the grouping structure applied at the transmitter. This reconstructed sequence may be provided to decoder 520, by which decoder 520 may produce the output bit estimate \hat{b}ₑ[0,1]^{K}. In some cases, decoder 520 may implement an iterative neural decoding architecture (e.g., TurboAE-based decoding), refining bit estimates through multiple iterations using learned belief propagation and/or convolutional processing.

Accordingly, FIG. 5 depicts a neural modulation-demodulation pipeline in which modulation and demodulation are no longer fixed signal processing blocks, but instead are learned transformations optimized jointly with encoding and decoding. The disclosed techniques enable adaptation of symbol representations to channel conditions, modulation order, and system constraints, thereby improving end-to-end performance, particularly in non-ideal conditions such as finite block lengths, non-Gaussian noise, or imperfect channel state information, etc.

Additionally, the modular structure shown in FIG. 5 allows the neural modulators and demodulators to be integrated with other neural network-based functional units, including precoders, combiners, equalizers, and power allocation networks, as described in related embodiments. MIMO system 500 may be trained using a combination of pre-training (e.g., encoder/decoder training on additive white Gaussian noise channels and supervised training of other modules) followed by end-to-end fine tuning, enabling coordinated optimization across all functional units.

FIG. 5 illustrates a further embodiment that is related to and may be implemented in conjunction with the architectures of FIG. 3 and/or FIG. 4, in which modulation and demodulation functionality are realized using neural modulator structures. In particular, one or more components or operations described with respect to FIG. 3 and/or FIG. 4 may be incorporated into the system of FIG. 5, and conversely, neural modulator structures of FIG. 5 may replace or augment modulation and/or demodulation components of FIG. 3 and FIG. 4. Thus, FIG. 5 may be viewed as an alternative or complementary implementation in which the functional units of FIG. 3 and FIG. 4 are extended to include neural modulation and demodulation processing within the overall MIMO communication framework.

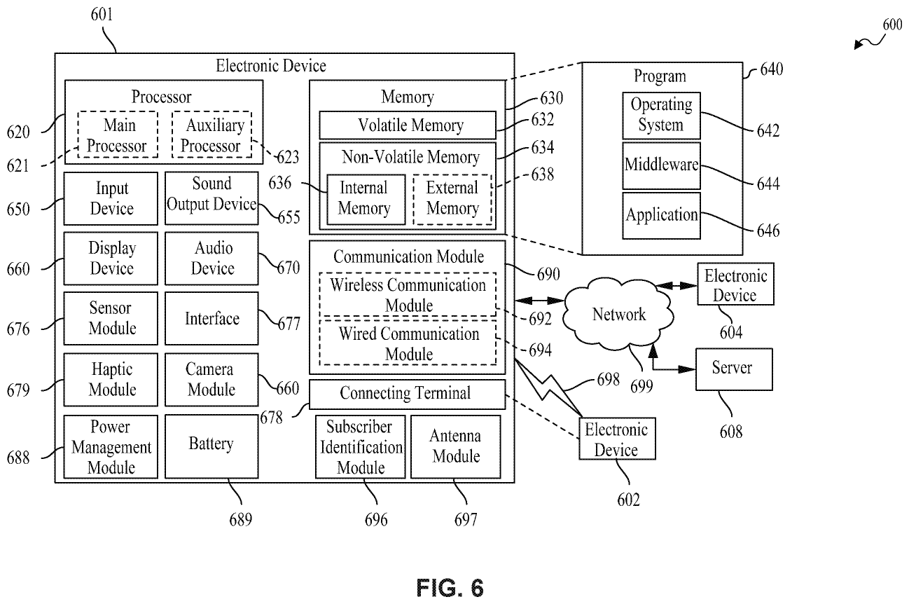

FIG. 6 depicts a block diagram of an electronic device in a network environment 600, according to an embodiment.

Referring to FIG. 6, an electronic device 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 697. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled with the processor 620 and may perform various data processing or computations.

As at least part of the data processing or computations, the processor 620 may load a command or data received from another component (e.g., the sensor module 676 or the communication module 690) in volatile memory 632, process the command or the data stored in the volatile memory 632, and store resulting data in non-volatile memory 634. The processor 620 may include a main processor 621 (e.g., a central processing unit (CPU) or an application processor (AP)), and an auxiliary processor 623 (e.g., a graphics processing unit (GPU), an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634. Non-volatile memory 634 may include internal memory 636 and/or external memory 638.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH™, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the SIM card 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of the operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

FIG. 6 may be understood as providing an example hardware and system-level implementation platform through which the disclosed neural network-based MIMO communication framework may be realized in practice. In particular, the processor 620 may be configured to execute program instructions stored in memory 630 to implement the transmitter-side and receiver-side neural network processing chains described herein, including encoder, modulator, precoder, combiner, equalizer, demodulator, and decoder neural network modules. In this regard, processor 620 may obtain channel matrices, perform singular value decomposition to derive right singular vectors, left singular vectors, and singular values, and provide these channel-dependent features as structured inputs to respective neural network modules, thereby enabling the domain-guided processing described with respect to the inventive concepts. Memory 630 may store trained model parameters, intermediate tensors, and training data, thereby supporting both inference operations for real-time communication and, in some embodiments, on-device or distributed training and fine-tuning of the neural network modules.

The communication module 690 and antenna module 697 may provide the physical interface to the communication medium and therefore may correspond to the hardware realization of the transmit and receive paths over which the learned signals are conveyed. In particular, the communication module 690 may interface with baseband and RF subsystems to transmit precoded and power-allocated signals generated by the neural transmitter chain, and to receive channel-affected signals for subsequent neural receiver processing. The antenna module 697 may enable spatial transmission and reception consistent with MIMO operation, thereby allowing the neural precoder, combiner, and equalizer modules to exploit spatial channel characteristics derived from the channel matrix. Accordingly, FIG. 6 illustrates that the disclosed modular neural network architecture is integrated into a practical electronic device in which processor-executed neural network models, memory-stored parameters, and communication hardware (including communication module 690 and antenna module 697) collectively implement an end-to-end learned MIMO communication system capable of adaptive, channel-aware transmission and reception in real-world network environments.

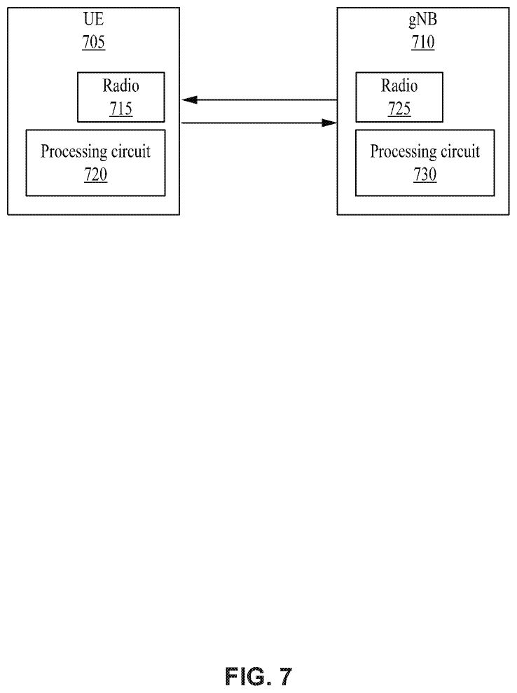

FIG. 7 shows a system including a UE 705 and a gNB 710, in communication with each other. The UE may include a radio 715 and a processing circuit (or a means for processing) 720, which may perform various methods disclosed herein, e.g., the method illustrated in FIG. 1. For example, the processing circuit 720 may receive, via the radio 715, transmissions from the network node (gNB) 710, and the processing circuit 720 may transmit, via the radio 715, signals to the gNB 710.

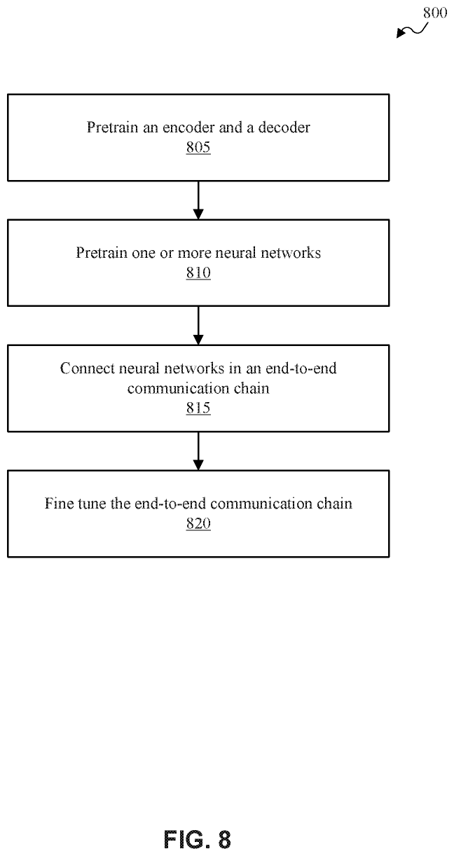

FIG. 8 depicts a flow diagram illustrating an example method 800 associated with the disclosed systems, in accordance with example implementations described herein. Method 800 may include a method of training a neural network-based communication system for multiple-input multiple-output communications. In some configurations, one or more aspects of method 800 may be implemented by or in conjunction with device 105, components of device 105, or any combination thereof. The depicted method 800 is just one implementation and one or more operations of method 800 may be rearranged, reordered, omitted, and/or otherwise modified such that other implementations are possible and contemplated.

At 805, method 800 may include pretraining an encoder and a decoder. For example, method 800 may include pretraining an encoder neural network and a decoder neural network of a MIMO communication system.

At 810, method 800 may include pretraining one or more neural networks. For example, method 800 may include pretraining at least one of a precoder neural network, a combiner neural network, and/or an equalizer neural network using channel-decomposition information derived from channel matrices.

Channel-decomposition information refers to structured parameters derived from a mathematical decomposition of a communication channel representation, such as a channel matrix associated with a multiple-input multiple-output (MIMO) system. In particular, channel-decomposition information may include components obtained via singular value decomposition (SVD) of the channel matrix, including one or more right singular vectors, one or more left singular vectors, and one or more singular values. These components collectively characterize spatial transmission modes, spatial reception modes, and corresponding channel gains, respectively, thereby capturing the underlying structure of the channel in a form that separates directional and magnitude-related effects. By providing these decomposed elements as inputs to respective neural network modules (e.g., precoder, combiner, and equalizer), the system leverages domain-specific channel knowledge to guide learning and processing, reducing complexity and improving convergence and performance relative to approaches that operate directly on raw channel representations.

At 815, method 800 may include connecting neural networks in an end-to-end communication chain. For example, method 800 may include connecting the encoder neural network, the decoder neural network, the precoder neural network, the combiner neural network, and the equalizer neural network in an end-to-end communication chain.

At 820, method 800 may include fine tuning the end-to-end communication chain. For example, method 800 may include jointly fine tuning, based on the pretraining, the end-to-end communication chain. Method 800 may include training the encoder neural network and the decoder neural network on an additive white Gaussian noise channel before the encoder neural network and the decoder neural network are used in the multiple-input multiple-output communications. Method 800 may include pretraining a power allocator neural network using a water-filling power allocation for a multiple-input multiple-output channel sample and signal-to-noise ratio information

In some cases, pretraining the encoder neural network and the decoder neural network may include training the encoder neural network and the decoder neural network on an additive white Gaussian noise channel before the encoder neural network and the decoder neural network are used in the multiple-input multiple-output communications.

In some examples, pretraining the precoder neural network, the combiner neural network, and the equalizer neural network may include training the precoder neural network using one or more right singular vectors as labels, training the combiner neural network using one or more left singular vectors as labels, and training the equalizer neural network using one or more singular values as labels.

In some cases, the methods described herein may include pretraining a power allocator neural network using a water-filling power allocation for a multiple-input multiple-output channel sample and signal-to-noise ratio information.

In some embodiments, following a pretraining phase for the respective neural network functional units, the end-to-end communication chain may be jointly fine-tuned by updating the encoder, decoder, precoder, combiner, and equalizer neural networks together on a MIMO channel so as to optimize overall system performance. In some implementations, the joint fine tuning includes minimizing a binary cross-entropy loss between an input bit sequence provided to the transmitter and a decoded output bit sequence generated at the receiver. For example, the loss function may compare input bits b with decoded output bits b, thereby enabling coordinated adaptation across the functional units based on end-to-end bit recovery performance rather than isolated block-level objectives.

In some implementations, the joint fine tuning includes minimizing a binary cross-entropy loss computed between an input bit sequence provided to the transmitter and a decoded output bit sequence generated at the receiver. In this context, the loss function measures a bit-wise discrepancy between transmitted bits and corresponding decoded bit probabilities, such that each decoded output represents a likelihood (e.g., a soft estimate) of a corresponding input bit. Accordingly, the loss quantifies the extent to which the decoded outputs deviate from the true transmitted bits, thereby directly reflecting bit recovery accuracy across the communication chain. Minimization of this loss therefore drives the system toward reducing bit error rates and improving end-to-end reliability, enabling coordinated adaptation across the functional units based on overall bit recovery performance rather than isolated block-level objectives.

In some embodiments, the disclosed neural network-based communication system may operate with channel matrices corresponding to either a fast-fading channel model or a slow fading channel model. In a fast-fading implementation, the channel matrix may vary across successive time instances, such that a channel realization Hₜ is independently sampled at each time step t. In a slow fading implementation, a same channel matrix may be maintained across an entire transmission block, for example by holding a single channel realization Hₜ constant for all time instances within the transmission block. These alternative channel models enable evaluation and operation of the communication chain under both rapidly varying channel conditions and channel conditions having longer coherence times.

In some examples, the methods described herein may include training a modulator neural network that maps groups of M encoded symbols to complex-valued modulation symbols. In some cases, the described methods may include training a demodulator neural network that maps each received complex-valued symbol to M real-valued outputs.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

A number of example implementations have been described. Nevertheless, it will be understood that various modifications may be made without departing from the spirit and scope of the disclosure. Accordingly, additional implementations are within the scope of the following claims. As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A communication system comprising:
a transmitter processing chain comprising an encoder neural network, a modulator neural network, and a precoder neural network;
a receiver processing chain comprising a combiner neural network, an equalizer neural network, a demodulator neural network, and a decoder neural network; and
a processor configured to obtain a channel matrix for a multiple-input multiple-output channel and to derive, from a singular value decomposition of the channel matrix, one or more right singular vectors, one or more left singular vectors, and one or more singular values, wherein:
the precoder neural network is configured to receive the one or more right singular vectors and to generate a precoding output for application to modulation symbols generated by the modulator neural network;
the combiner neural network is configured to receive the one or more left singular vectors and to generate a combining output for processing a received signal; and
the equalizer neural network is configured to receive the one or more singular values and to generate an equalization output for compensating channel-dependent distortion prior to demodulation and decoding.

2. The communication system of claim 1, wherein:
the encoder neural network and the modulator neural network are implemented as a combined encoder-modulator neural network, and
the demodulator neural network and the decoder neural network are implemented as a combined demodulator-decoder neural network.

3. The communication system of claim 1, further comprising a power allocator neural network configured to:
receive signal-to-noise ratio information and equalization-related information; and
generate a power allocation output for application to symbols produced by the modulator neural network, the power allocator neural network being disposed before the precoder neural network.

4. The communication system of claim 3, further comprising a power deallocator neural network configured to:
receive the signal-to-noise ratio information and the equalization-related information; and
generate a receiver-side compensation output that compensates for transmit-side power allocation and channel-induced gain variation, the power deallocator neural network being disposed in the receiver processing chain.

5. The communication system of claim 1, wherein:
the modulator neural network is configured to receive groups of M encoded symbols and generate a respective complex-valued modulation symbol for each group, and
the demodulator neural network is configured to receive a complex-valued received symbol and to generate M real-valued outputs corresponding to the complex-valued received symbol.

6. The communication system of claim 5, wherein:
the modulator neural network is applied to each of the groups of M encoded symbols using shared learned parameters, and
the demodulator neural network is applied to each received complex-valued symbol of a plurality of received complex-valued symbols.

7. The communication system of claim 1, wherein the one or more singular values are provided to the equalizer neural network as diagonal elements of a diagonal matrix or as a vector formed from the diagonal elements.

8. The communication system of claim 1, wherein, for each of a plurality of time instances, the one or more right singular vectors, the one or more left singular vectors, and the one or more singular values correspond to a same channel matrix associated with the respective time instance.

9. The communication system of claim 1, wherein a transmit signal obtained by applying the precoding output to modulation symbols is normalized to satisfy a transmit power constraint before transmission over the multiple-input multiple-output channel.

10. The communication system of claim 1, wherein the communication system is configured for point-to-point wireless communication between a user equipment and a base station.

11. A method of training a neural network-based communication system for multiple-input multiple-output communications, the method comprising:
pretraining an encoder neural network and a decoder neural network;
pretraining at least two neural networks selected from a group consisting of a precoder neural network, a combiner neural network, and an equalizer neural network using channel-decomposition information derived from one or more channel matrices;
connecting the encoder neural network, the decoder neural network, and the at least two neural networks in an end-to-end communication chain; and
jointly fine tuning, based on the pretraining, the end-to-end communication chain.

12. The method of claim 11, wherein pretraining the encoder neural network and the decoder neural network comprises training the encoder neural network and the decoder neural network on an additive white Gaussian noise channel before the encoder neural network and the decoder neural network are used in the multiple-input multiple-output communications.

13. The method of claim 11, wherein pretraining the precoder neural network, the combiner neural network, and the equalizer neural network comprises training the precoder neural network using one or more right singular vectors as labels, training the combiner neural network using one or more left singular vectors as labels, and training the equalizer neural network using one or more singular values as labels.

14. The method of claim 11, further comprising pretraining a power allocator neural network using a water-filling power allocation for a multiple-input multiple-output channel sample and signal-to-noise ratio information.

15. The method of claim 11, wherein jointly fine tuning the end-to-end communication chain comprises minimizing a binary cross-entropy loss between input bits and decoded output bits.

16. The method of claim 11, wherein the channel matrices correspond to a fast-fading channel in which the channel matrices vary across time instances or to a slow fading channel in which a same channel matrix is held across a transmission block.

17. The method of claim 11, further comprising:
training a modulator neural network that maps groups of M encoded symbols to complex-valued modulation symbols; and
training a demodulator neural network that maps each received complex-valued symbol to M real-valued outputs.

18. A non-transitory computer-readable medium storing instructions that, when executed by one or more processors, cause the one or more processors to:
obtain information bits for transmission over a multiple-input multiple-output channel;
obtain a channel matrix and derive, from a singular value decomposition of the channel matrix, one or more right singular vectors, one or more left singular vectors, and one or more singular values;
encode the information bits using an encoder neural network;
modulate encoded outputs using a modulator neural network to generate modulation symbols;
generate, using at least one neural network selected from a group consisting of a precoder neural network, a combiner neural network, and an equalizer neural network, at least one output selected from a group consisting of:
a precoding output generated based on the one or more right singular vectors;
a combining output generated based on the one or more left singular vectors; and
an equalization output generated based on the one or more singular values; and
recover an estimate of the information bits by demodulating and decoding a received signal based on the at least one output.

19. The non-transitory computer-readable medium of claim 18, wherein the instructions further cause the one or more processors to generate, using a power allocator neural network that receives signal-to-noise ratio information and equalization-related information, a power allocation output before generation of the precoding output.

20. The non-transitory computer-readable medium of claim 19, wherein the instructions further cause the one or more processors to generate, using a power deallocator neural network that receives the signal-to-noise ratio information and the equalization-related information, a receiver-side compensation output after generation of the combining output.
